(19) United States
(12) Patent Application Publication
(10) Pub. No.: US 2012/0235371 A1
(43) Pub. Date: Sep. 20, 2012

(54) MULTIPOSITION MECHANIC'S CREEPER

(76) Inventor: Craig S. SMITH, Waterloo, IA (US)

(21) Appl. No.: 13/048,396

(22) Filed: Mar. 15, 2011

(51) Int. Cl. B25H 5/00; B62B 11/00

(52) U.S. Cl. 280/32.6

(57) ABSTRACT

A multiposition mechanic's creeper for use by a worker wherein the creeper transforms into multiple working configurations for supporting the worker. The creeper includes a main creeper frame, a back frame pivotally connected with the main frame, and a seat frame pivotally carried by the back frame. A guide assembly is connected between a lower end of the back frame and the main frame to guide movement of the back frame from a flat configuration to an upright chair configuration. An inclination mechanism provides for adjusting the inclination of the back frame relative to the seat frame in a flat configuration to provide a plurality of inclined back configurations. A pair of side braces pivotally connect the main frame and back frame on opposing sides.

### BACKGROUND OF THE INVENTION

The invention relates to a mechanic's creeper and more particularly to a mechanic's creeper having multiple positions into which it may be transformed between a flat creeper, a flat creeper with an inclined back, and a chair.

During the maintenance on automobiles and the like, it is often required that the mechanic be able to work under the chassis of the vehicle. In the past it has been known to use flat surfaces on wheels, known as creepers, enabling the mechanic to lie in a supine position and work underneath the automobile. Further, mechanics often use seats when working about the exterior of an automobile. The seats typically include only a bottom seat and no back support.

The problem has arisen in that to work on a vehicle, the mechanic uses a creeper for work underneath the automobile chassis and a separate seat for work around the automobile's exterior. When a worker needs a separate work platform, such as a flat creeper and a separate seat creeper, additional need for space and expense is required. When considering that many automotive shops work on several cars at the same time, the number of work platforms really increases. Furthermore, the work area around the automobile quickly becomes congested considering the many tools that are used on the automobile, such as computer aided and diagnostics in general and hand held tools along with replacement parts that may be lying around the work area. Accordingly, depending on the work activity, either the seat or the flat creeper are not being utilized and really take up space around the work area, further congesting the work area and making it more difficult for an orderly work place to be maintained.

In an effort to alleviate that problem, several convertible creepers have been proposed which convert between two positions. Typically the convertible creeper includes conversion from a flat creeper to a seat as shown in U.S. Pat. Nos. RE35,732, 6,199,877 B1, 6,834,868 B1, 6,969,077 B2, 5,707,067, and 6,425,590. While these creepers may be satisfactory for their intended purposes, they have not provided a creeper having more than two positions, and one which provides adjustability for the back while working underneath an automobile so the worker may have better vision than when lying flat. In addition, the seat supports have provided no back support.

U.S. Pat. No. 6,425,590 discloses a combination mechanic's creeper having a flat position, a chair position, and intermediate positions. However, a relatively complicated and expensive hydraulic mechanism is needed to adjust the seat and back frames in intermediate positions between a flat configuration and a full chair configuration. In this case, the back and seat always move together rather than the back moving separately relative to the seat. This requires additional framing and expense.

Accordingly, an object of the present invention is to provide an improved mechanic's creeper having multiple work configurations to support a worker in most of the positions needed for vehicle service and repair.

Another object of the present invention is to provide a multiposition mechanic's creeper which includes an upright chair configuration with a simplified frame that allows the worker to have a typical back support, as in a chair.

Yet another object of the present invention is to provide a multiposition mechanic's creeper having three functional support configurations whereby a worker may be supported in three different positions for performing the multiple tasks needed to work on automobiles.

Yet another object is to provide a multiposition mechanic's creeper for transforming between a flat configuration, an inclined back configuration, and a chair configuration.

### SUMMARY OF THE INVENTION

The above objectives are accomplished according to the present invention by providing a multiposition mechanic's creeper for use by a worker wherein the creeper transforms into multiple working positions for supporting the worker underneath and around a vehicle. The creeper includes a main creeper frame and a plurality of wheels carried by the main creeper frame supporting the main frame on a work floor for mobility. A back frame is pivotally connected with the main frame for providing a back support in one or more of the multiple positions, and a seat frame is pivotally carried by the back frame for providing a seat support in one or more of the multiple positions. The combination of a main wheeled frame, a back frame pivotally carried by the main frame, and a seat frame pivotally carried by the back frame provides simplified framework from which multiple work positions may be had. A guide assembly is connected between the back frame and the main frame to guide movement of the back frame from a flat position for supporting the worker in a supine configuration to an upright chair position in which the worker is supported by the seat frame and back frame. An inclination mechanism adjusts the inclination of the back frame relative to the seat frame. Preferably, the inclination mechanism includes an index member carried by the back frame and a latch member for engaging the index mechanism. Advantageously, a back support is pivotally carried by the back frame so that it pivots relative to the back frame, and the index member is carried by the pivotal back support. In that manner, the back support may be pivoted out of the back frame and inclined relative to the seat frame which remains in a flat position in the main frame. Advantageously, the guide assembly includes an elongated guide carried by the main frame and a guide follower carried by the back frame for guiding a lower, load bearing end of the back frame into a support position on the main frame. The guide includes a guide rail having one end terminating at a frame support for supporting the back frame in a chair configuration. The one end includes a curved portion which the guide follower follows to guide the back frame into the frame support wherein the chair configuration is maintained. The guide follower includes a first guide part carried by the back frame lower end above the guide rail, and a second guide part disposed underneath the guide rail. The second guide part is carried by a pair of pivotal arms on either end thereof. A pair of side braces are pivotally connected to the main frame and back frame on opposing sides of the main and back frames. A chair lock is connected between the side braces and the seat frame for maintaining the seat and back frame in the chair configuration raised above the main frame. The chair lock includes a first part carried by the side braces and a second part carried by the seat frame which interlock to maintain the chair configuration.

### DESCRIPTION OF THE DRAWINGS

The construction designed to carry out the invention will hereinafter be described, together with other features thereof.

The invention will be more readily understood from a reading of the following specification and by reference to the accompanying drawings

FIG. 1 is a top plan view of a multiposition mechanic's creeper constructed according to the present invention;

FIG. 2 is an illustration of a multiposition mechanic's creeper in a chair configuration;

FIG. 3 is a perspective view of a multiposition mechanic's creeper illustrating the guide assembly for guiding the back into a support position wherein the back frame supports the chair configuration.

FIG. 4 is a bottom perspective view of the multipositional mechanic's creeper shown in FIG. 2;

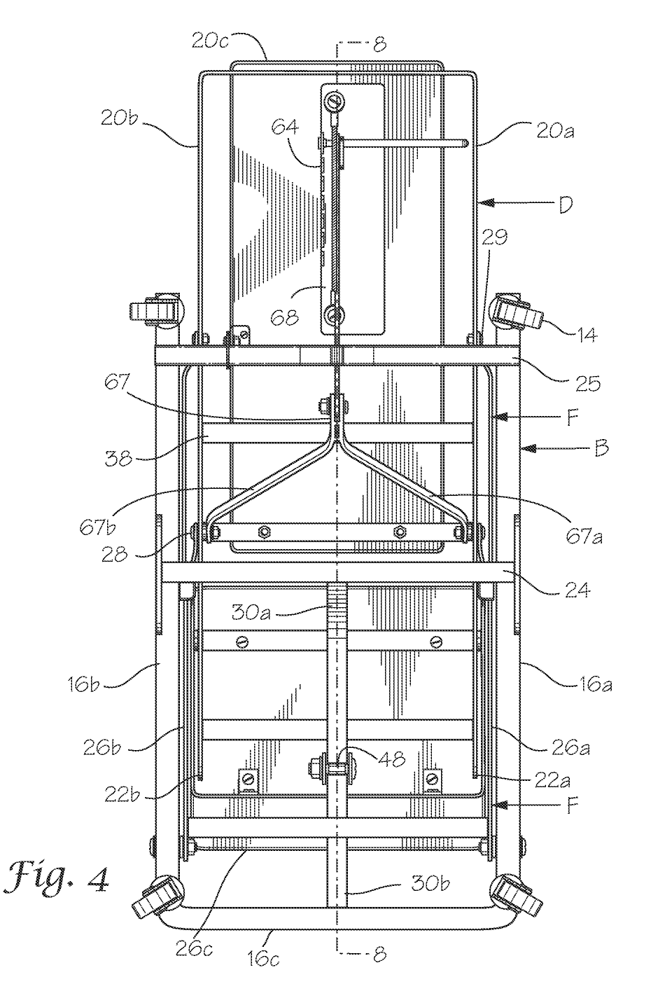

FIGS. 5, 6, and 7 are side views of a multiposition mechanic's creeper in a transitional position in which the creeper is being transformed from a flat configuration to a chair configuration, and illustrating a chair lock for locking the creeper in a chair configuration; and

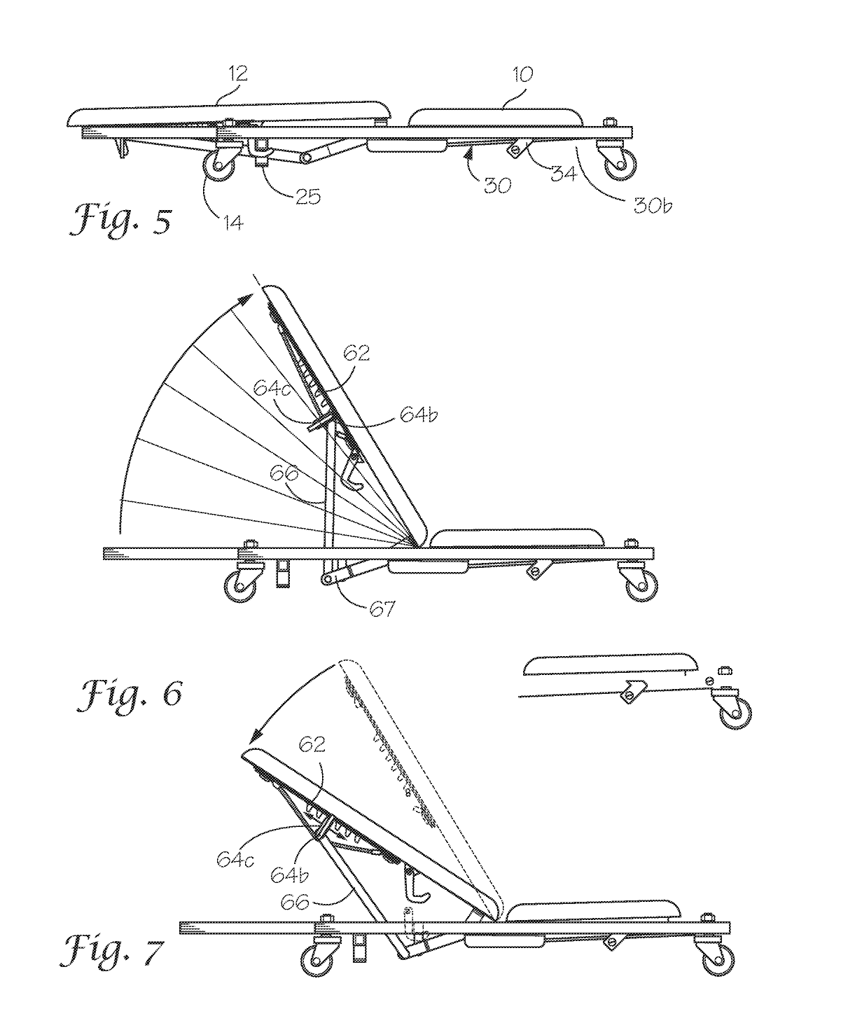

FIGS. 8A and 8B are illustrations of a transitional position of the mechanic's creeper having a guide assembly for guiding the back into the chair configuration.

### DESCRIPTION OF A PREFERRED EMBODIMENT

Referring now to the drawings, the invention will not be described in more detail.

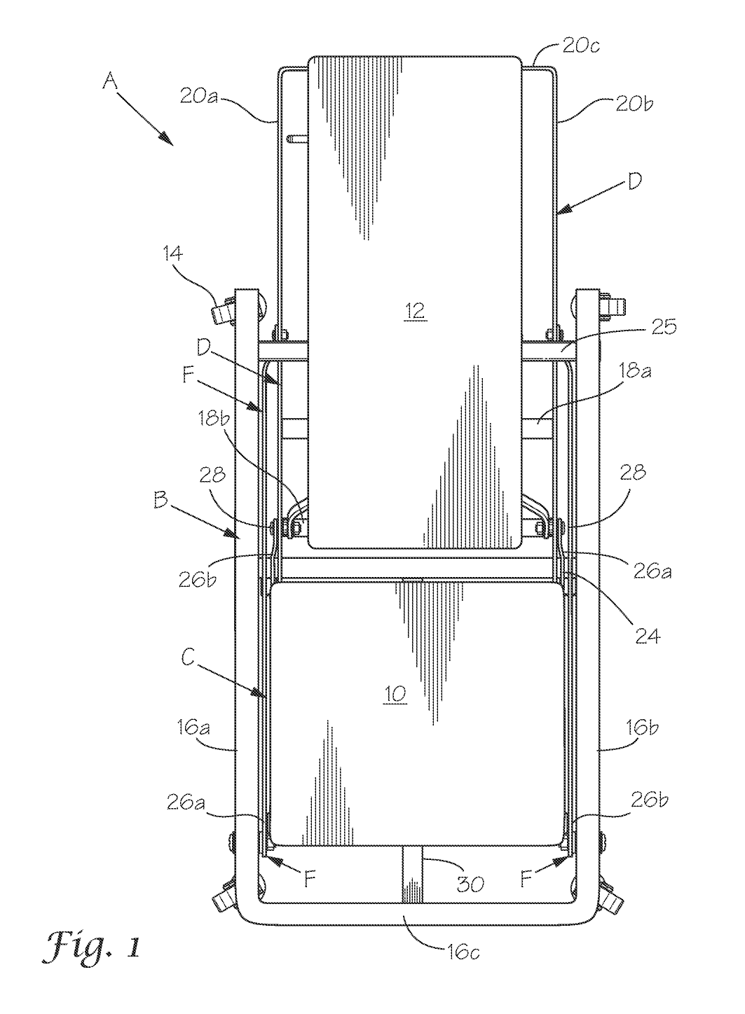

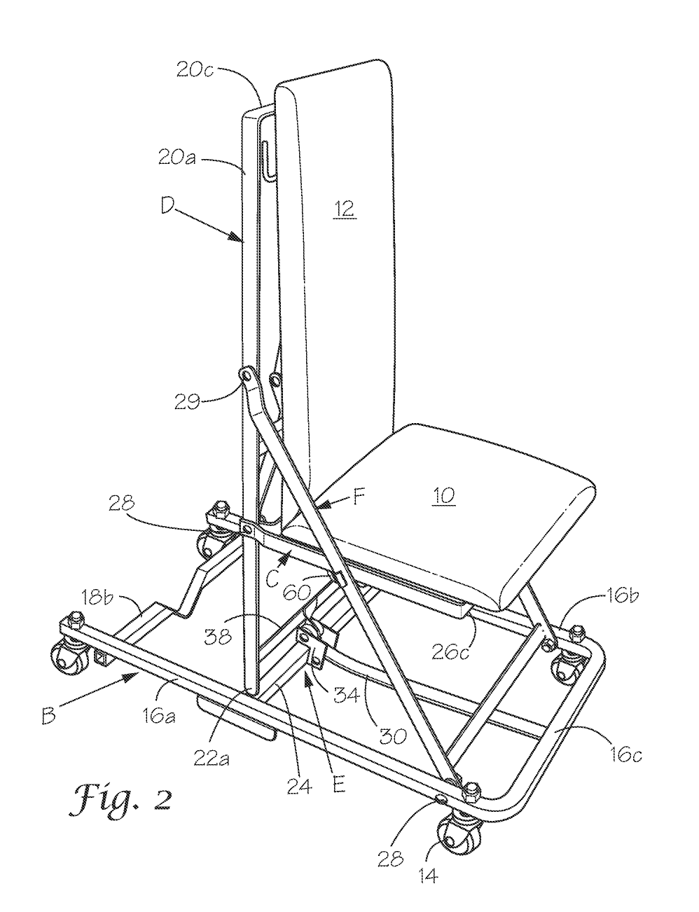

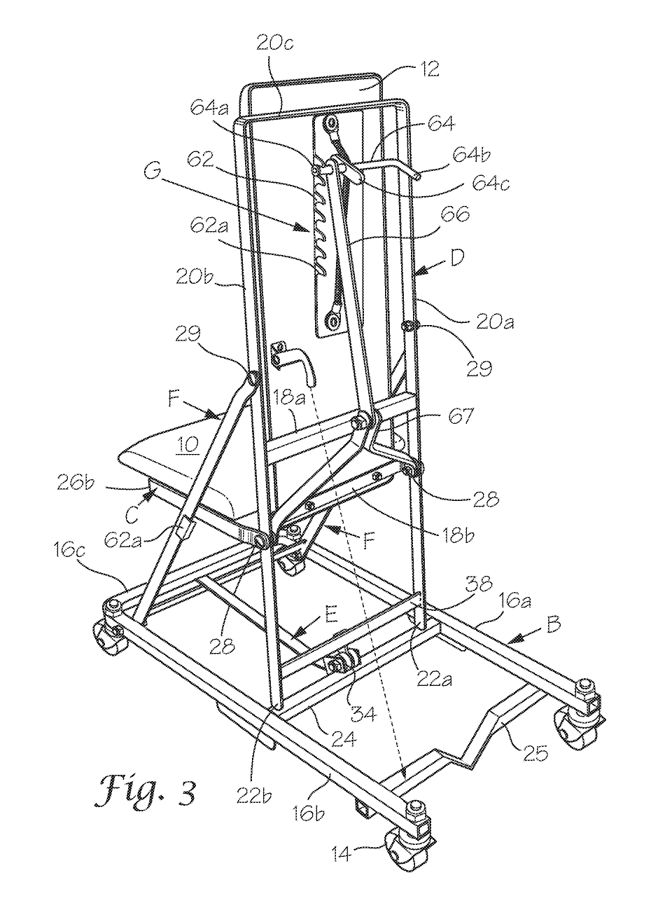

As can best be seen in FIG. 1, the mechanic's creeper is shown in a flat configuration for supporting a worker in a supine position. FIG. 2 shows the mechanic's creeper in an inclined back position for supporting the worker in a plurality of raised back positions where the worker has a better view, and for uses when the vehicle is raised. FIG. 3 shows the creeper in a chair configuration wherein the worker is seated with back support.

Referring to FIG. 1, a multiposition mechanic's creeper, designated generally as A, is illustrated having a main frame B, a seat C, and a back frame D. Support pads 10 and 12 are carried by the seat and back frames, respectively. A guide assembly E, interconnecting the back frame and main frame, guides the back frame into a support position for the seat frame in the chair configuration of the creeper. For this purpose, the seat frame is pivotally carried on the back frame.

A pair of side braces F are pivotally attached to the back frame at pivot bolts 29 and the main frame at pivot bolts 28. An inclination mechanism adjusts the inclination of the back frame relative to the seat frame.

Referring now in more detail to FIG. 1, main creeper frame B includes a plurality of wheels 14 to provide mobility for the creeper. The main creeper frame includes a pair of side frames 16a and 16b, and a front frame member 16c. Intermediate cross-frame members 24 and 25 extend underneath and across the main frame.

Back frame D includes a U-shaped frame including side frame members 20a and 20b made integral with an end frame member 20c. Side frame members 20a and 20b terminate in load supporting legs 22a and 22b having free ends. Cross-frame members 18a and 18b are integrally connected between sides 20a and 20b. Seat frame D includes side frame members 26a and 26b pivotally attached to back frame side frame members 20a and 20b by means of pivot pins 28, or other suitable pivot means. Support pad 12 is carried by the back frame C, and support pad 10 is carried by seat frame C.

Referring now in more detail to guide assembly E, a guiderail 30 extends from the front frame 16c of main frame B to a cross-frame support 24 of main frame B. The guiderail is curved downwardly at its end 30a. A cam follower 34 will slide downwardly from cross-frame support rail 24 unless frame legs 22a, 22b are fully supported on cross-frame support 24 and locked into position. While the guiderail is shown mounted centrally widthwise of main frame B, there may also be two guiderails used at the sides. Cam follower 34 is carried by a crossbar 38 of back frame D. The guide follower 34 includes a first part 40, and a second guide part 42, which follow the top and bottom of guiderail 30, respectively. As illustrated, the first guide part 40 includes a pair of rollers 43 mounted on a pivot pin 44. The pivot shaft is mounted through an opening (not shown) in a stub shaft 46 carried by cross bar 38. The second guide part 42 includes a roller 48. The guide follower further includes L-shaped arms 50 wherein the upper arms are connected to pivot pin 44 and the lower arms are connected to roller 48. In this manner, the upper guide part and the lower guide part straddle the guiderail.

In use, the upper guide part stays along the guiderail, particularly the upperly curved portion 30a until the free ends 22a and 22b of the back frame engage on top of cross-frame support 24. It is interesting to note that the configuration of the guide follower and the guiderail will not allow the chair configuration to be assumed until the free legs of the back frame are locked on top of the cross-frame support. This is because if the guide follower rises against the cross-frame support, but the legs are not lifted on top of the cross-support, the guide follower would allow the back frame to slide back down. In this manner, a safety feature is provided since the chair will not stay upright until the free ends of the back frame are resting on the support and chair lock 60 is engaged.

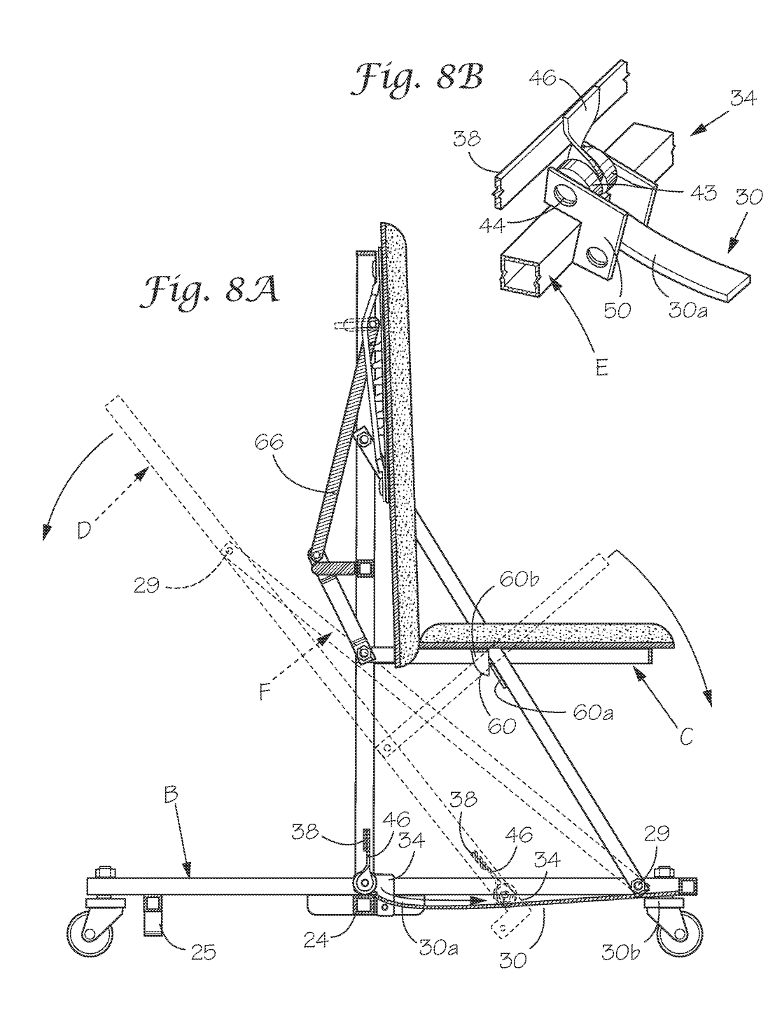

As can best be seen in FIG. 8A, side braces F are pivotally connected between base frame B and the back frame D by pivot pins 28, 29. Since the seat frame is pivotally attached to the back frame D, the seat frame C is held in a raised, generally horizontal position, by means of a chair lock 60 that includes a first abutment 60a carried by the side brace, and a second abutment 60b carried by the seat frame. These two abutments interlock, as can best be seen in FIGS. 2 and 8A. It is not until the seat frame C is raised and the seat frame is pulled forward to collapse the back frame downwardly that the chair lock position is disabled. Thus, another safety feature is provided in that the chair configuration will not collapse unless a manual movement of the seat frame upward is caused to happen.

Referring in more detail to inclination mechanism G, an index member 62, including index notches 62a, is carried by the back support 12. The index member is not attached to the back frame. In addition, a latch member 64 is carried by the back frame. The latch member includes an engagement rod 64a and a handle 64b. A disengagement arm 64c pulls the rod 64a out of the notches of index member 62 when rotated. Latch member 64 is carried on the end of an articulated linkage 66 pivotally attached to the back frame. The articulating linkage includes link 66 pivotally connected to yoke 67 where yoke 67 includes arms 67a and 67b connected at pivot 28 to back frame D. A tensioning member 68, which may simply be a bungee cord, holds the latch member in place while allowing the latch member to slide out of the index opening for adjustment when disengagement arm 64c is rotated.

While a preferred embodiment of the invention has been described using specific terms, such description is for illustrative purposes only, and it is to be understood that changes and variations may be made without departing from the spirit or scope of the following claims.

Thus, it can be seen that an advantageous construction for a multi-position mechanic's creeper can be had according to the invention wherein a flat position, an inclined back position, and a raised chair position are provided in a simple and easy-to-use construction. In use, when changing from the flat configuration to the chair configuration, the seat raises the main frame as the back frame moves into an upright position because the seat is pivotally carried by the back frame. The back frame is guided by a guide assembly into a locked chair position by a chair lock. Since the back support and the back frame are separate parts that move relative to each other, the back support may be raised from the flat configuration while the back frame and seat remain flat. In this manner, a plurality of inclined back support positions are provided from the flat creeper.

What is claimed is:

1. A multiposition mechanic's creeper for use by a worker wherein said creeper transforms into multiple working positions for supporting the worker underneath and around a vehicle comprising:
a main creeper frame;
a plurality of wheels carried by said main creeper frame supporting said main frame on a work floor for mobility;
a back frame pivotally connected with said main frame for providing a back support in one or more of said multiple positions;
a seat frame pivotally carried by said back frame for providing a seat support in one or more of said multiple positions;
a back frame having an upper frame end and a lower frame end;
a guide assembly connected between said lower frame end of said back frame and said main frame to guide movement of said back frame from a flat position for supporting the worker in a supine configuration to a generally upright chair position in which said worker is supported by said seat frame and back frame.

2. The creeper of claim 1 including an inclination mechanism for adjusting the inclination of the back frame relative to said seat frame.

3. The creeper of claim 2 wherein said inclination mechanism includes an index member carried by said back frame and a latch member for engaging said index mechanism.

4. The creeper of claim 3 including a back support pivotally carried by said back frame which pivots relative to said back frame.

5. The creeper of claim 4 wherein said index member is carried by said pivotal back support and said latch member is pivotally carried by said back frame for engaging said index member.

6. The creeper of claim 5 wherein said index member includes a plurality of index openings and said latch member engages one of said index openings to fix said back support at a corresponding inclination.

7. The creeper of claim 6 including a tension member engaging said latch member to maintain said latch member and index opening engaged, and said tension member being tensioned outwardly for disengagement.

8. The creeper of claim 1 when said guide assembly includes a guide carried by said main frame for said back frame lower end, and a guide follower carried by said back frame lower end engaging said guide so that said back frame is guided into a support position.

9. The creeper of claim 8 wherein said guide includes a guiderail having a first end and a second end terminating at a frame support for said back frame in a chair configuration, and said second end includes a curved portion which said guide follower follows to guide said back frame into a support position wherein said chair configuration is maintained.

10. The creeper of claim 9 wherein said guiderail is carried generally centrally along a length of said main frame, and a support bar extending across the width of the main frame to which the guiderail is connected.

11. The creeper of claim 10 wherein said guide follower includes a first guide part carried by said back frame lower end above said guiderail, and a second guide part disposed underneath said guiderail.

12. The creeper of claim 11 wherein said first guide part includes at least one roller carried by said back frame, and said second guide part includes a guide roll for engaging a bottom said of said guiderail; and said guiderail and guide part being interconnected.

13. The creeper of claim 12 wherein said guide roll is carried by a pair of pivotal arms on either end thereof.

14. The creeper of claim 1 wherein said back frame includes a weight bearing lower end and said guide assembly includes a longitudinal guide carried by said main frame which supports said weight bearing lower end, a chair support bar carried across said mainframe, and a guide follower carried by said back frame for guiding said weight bearing lower end onto said support bar wherein said chair configuration is maintained.

15. The creeper of claim 1 including a pair of side braces pivotally connected to said main frame and back frame on opposing sides of said main and back frames.

16. The creeper of claim 15 including a chair lock connected between said side braces and said seat frame for maintaining said seat and back frame in said chair configuration raised above said main frame.

17. The creeper of claim 16 wherein said chair lock includes a first part carried by said side braces and a second part carried by said seat frame which interlock to maintain said chair configuration.

18. The creeper of claim 17 wherein said first guide part includes a first abutment and a second part includes a second abutment wherein said second abutment must be raised above said first abutment to release said seat from said chair configuration.

19. The creeper of claim 17 wherein said seat frame and back frame will not be interlocked in said chair configuration unless said weight supporting lower end is properly supported on said transverse support bar.

20. A multiposition mechanic's creeper for use by a worker wherein said creeper transforms into multiple working configurations for supporting the worker underneath and around a vehicle comprising:
a main creeper frame;
a plurality of wheels carried by said main creeper frame supporting said main frame on a work floor for mobility;
a back support for providing a back support;
a seat support for providing a seat support in one or more of said multiple positions;
said back frame having an upper frame end and a lower frame end;
a flat configuration in which said back and seat supports support the worker in a supine position;
an inclined back configuration in which said back support is tilted upward from said flat position to support the worker in an inclined seated position;
a chair configuration in which said seat support is raised above the main frame and said back support is generally upright for supporting the worker as in a chair.

21. The creeper of claim 1 including a guide assembly carried by said main frame to guide movement of a weight supporting lower end of said back frame from said flat configuration to said chair configuration.

22. The creeper of claim 21 wherein said inclination mechanism includes an index member carried by said back support and a latch member for engaging said index member for adjusting the inclination of the back frame relative to said seat frame.

23. The creeper of claim 22 including a tension member engaging said latch member to maintain said latch member and index member engaged.

24. The creeper of claim 21 wherein said back frame includes a weight bearing lower end and said guide assembly includes a longitudinal guide carried by said main frame which guides said weight bearing lower end, a chair support bar carried across said main frame, and a guide follower for guiding said weight bearing lower end onto said support bar wherein said chair configuration is maintained.

25. The creeper of claim 24 wherein said weight bearing free end of said back frame includes a pair of brace legs terminating in free ends.

26. The creeper of claim 24 including a pair of side braces pivotally connected to said main frame and back frame on opposing sides of said main and back frames.

27. The creeper of claim 26 including a chair lock connected between said side braces and said seat frame for maintaining said seat and back frame in said chair configuration raised above said main frame.

28. The creeper of claim 27 wherein said seat frame and back frame will not be interlocked in said chair configuration unless said weight supporting lower end is properly supported on said chair support bar.

29. A multiposition mechanic's creeper for use by a worker wherein said creeper transforms into multiple working configurations for supporting the worker underneath and around a vehicle comprising:
a main creeper frame;
a plurality of wheels carried by said main creeper frame supporting said main frame on a work floor for mobility;
a back frame pivotally connected with said main frame for providing a back support in one or more of said multiple configurations;
a seat frame pivotally carried by said back frame for providing a seat support in one or more of said multiple configurations;
said back frame having an upper frame end and a lower frame end;
a guide assembly connected between said lower end of said back frame and said main frame to guide movement of said back frame from a flat position for supporting the worker in a supine configuration to an upright chair position in which said worker is supported by said seat frame and back frame;
an inclination mechanism for adjusting the inclination of the back frame relative to said seat frame; and
a pair of side braces pivotally connected to said main frame and back frame on opposing sides of said main and back frames.

30. The creeper of claim 29 including a tension member engaging said latch member to maintain said latch member and index member engaged.

31. The creeper of claim 29 wherein said back frame includes a weight bearing lower end and said guide assembly includes a longitudinal guide carried by said main frame which supports said weight bearing lower end, a chair support bar carried across said main frame, and a guide follower carried by said back frame for guiding said weight bearing lower end onto said support bar wherein said chair configuration is maintained.

32. The creeper of claim 29 including a chair lock connected between said side braces and said seat frame for maintaining said seat and back frame in said chair configuration raised above said main frame.

33. The creeper of claim 32 wherein said first chair lock includes a first abutment and a second part includes a second abutment wherein said second abutment must be raised above said first abutment to release said seat from said chair configuration.

34. The creeper of claim 33 wherein said seat frame and back frame will not be interlocked in said chair configuration unless said weight supporting lower end is properly supported on said chair support bar.
